(19) United States
(12) Patent Application Publication
(10) Pub. No.: US 2025/0210964 A1
(43) Pub. Date: Jun. 26, 2025

(54) SYSTEM AND METHOD FOR OVERCURRENT PROTECTION USING DYNAMIC TRIP CURVE EVALUATION

(71) Applicant: TOWA Industries Inc., Campbell, CA (US)

(72) Inventors: Richard K. Ogawa, SR., Campbell, CA (US); Ronald L. Silorio, Campbell, CA (US); James George Hanlon, Campbell, CA (US)

(21) Appl. No.: 19/077,572

(22) Filed: Mar. 12, 2025

Related U.S. Application Data
(63) Continuation-in-part of application No. 17/876,949, filed on Jul. 29, 2022.
(60) Provisional application No. 63/654,648, filed on May 31, 2024.
(60) Provisional application No. 63/666,759, filed on Jul. 2, 2024.
(60) Provisional application No. 63/673,700, filed on Jul. 20, 2024.
(60) Provisional application No. 63/673,702, filed on Jul. 20, 2024.
(60) Provisional application No. 63/747,747, filed on Jan. 21, 2025.

(51) Int. Cl. H02H 3/093; H02H 1/00; H02H 3/02; H02H 3/06; H02J 13/00

(52) U.S. Cl. CPC H02H 3/093; H02H 1/0053; H02H 1/0061; H02H 3/021; H02H 3/066; H02J 13/00001; H02J 13/00002; H02J 13/00036; H02J 13/0005; H02J 2310/60

(57) ABSTRACT

An intelligent circuit breaker system and method for managing overcurrent conditions includes a current sensor configured to measure electrical current applied to a power line load, a memory storing trip curve data, and a processor configured to evaluate the measured current against a pre-established threshold. Upon detecting an overcurrent condition, the processor starts a timer, evaluates the duration of the overcurrent against the trip curve, and disconnects the load when specified conditions are met. The system can dynamically adjust threshold values based on environmental factors, log operational data, and select appropriate trip curves for specific load types. A user interface provides real-time feedback on current values, timer status, and load disconnection events. Additionally, the system can automatically reset and reconnect the load upon return to safe operating conditions. The functionality is further embodied in a method and as computer-readable instructions for execution by a processor, providing a robust, adaptable, and efficient solution for modern overcurrent protection.

### CROSS-REFERENCE TO RELATED APPLICATIONS

This application claims priority to co-pending U.S. Provisional Patent Application Ser. Nos. 63/654,648, filed on May 31, 2024; 63/666,759, filed Jul. 2, 2024; 63/673,700, filed on Jul. 20, 2024; 63/673,702, filed on Jul. 20, 2024; and 63/747,747 filed on Jan. 21, 2025, and the disclosures of each thereof are hereby incorporated by reference in their entirety. This application is also a continuation-in-part to co-pending U.S. patent application Ser. No. 17/876,949, filed on Jul. 29, 2022 and the disclosure thereof is also hereby incorporated by reference in its entirety.

### TECHNICAL FIELD OF THE DISCLOSURE

This application relates generally to power distribution management. The application relates more specifically to power distribution management designed to provide power simultaneously to demand based devices and power controlled outlets to keep total power consumption below a This application relates generally to electrical protection systems, specifically devices and methods for safeguarding electrical circuits from overcurrent conditions that could result in damage, inefficiency, or safety hazards. The application relates more particularly to intelligent circuit breakers that incorporate real-time monitoring, adaptive control, and dynamic trip curve evaluation to provide precise and reliable protection. This includes the integration of microcontrollers, sensors, and memory for managing current thresholds, logging events, and enabling advanced functionalities such as environmental adaptability and user feedback. These systems are applicable in residential, commercial, and industrial electrical systems to enhance safety, efficiency, and operational continuity.

### BACKGROUND OF THE DISCLOSURE

In electrical systems, circuit breakers are critical for protecting circuits from damage caused by overcurrent conditions, such as overloads or short circuits. Conventional designs typically use thermal or magnetic mechanisms to disconnect the circuit when current exceeds predefined limits. While effective for many applications, these traditional approaches often rely on static trip thresholds and fixed operational parameters that may not address the complexities of modern electrical systems.

Transient inrush currents, such as those occurring during motor startups or capacitor charging, can cause conventional circuit breakers to trip unnecessarily, leading to operational disruptions. Conversely, sustained overcurrent conditions that persist beyond safe levels may not always be addressed promptly, especially in systems with mixed load profiles or varying environmental factors.

In addition, many current circuit breaker designs lack the ability to provide detailed system feedback or diagnostics to operators, limiting their ability to monitor and adjust system performance. Environmental factors, such as temperature and humidity, may also affect circuit breaker performance, but conventional systems are typically not designed to adapt to such variations.

Existing approaches demonstrate a need for enhanced circuit breaker designs capable of addressing these challenges.

### SUMMARY OF THE DISCLOSURE

The described system provides an intelligent approach to managing overcurrent conditions in a power line load by incorporating real-time monitoring, processing, and control. It employs a current sensor to measure the electrical current applied to the load and a processor to evaluate the measured current against pre-established thresholds. Trip curve data stored in a memory enables the processor to determine when the current exceeds safe operating levels and initiates a timer to track the duration of the overcurrent condition. If the current exceeds both the specified magnitude and duration defined by the trip curve, the processor sends a control signal to disconnect the load.

The system is further enhanced with additional functionalities. It can dynamically adjust the pre-established threshold values based on environmental factors such as temperature and humidity, ensuring reliable operation under varying conditions. A relay is operatively coupled to the processor, enabling precise load disconnection when unsafe conditions are detected. To facilitate diagnostics and monitoring, the system logs critical information, including current values, timer durations, and disconnection events. Multiple predefined trip curves can be stored in memory, allowing the processor to select an appropriate curve based on the specific characteristics of the connected load.

User interaction and status feedback are supported through a user interface, which displays real-time current measurements, timer status, and whether the load has been disconnected. Additionally, the system is designed to automatically reset the timer and reconnect the load once the current returns to a safe level for a predefined recovery period. These features ensure minimal disruption while maintaining safety and reliability.

The system's functionality can also be implemented as a method and as software instructions stored on a non-transitory computer-readable medium. The method includes measuring current, storing trip curve data, comparing current values with thresholds, starting a timer for overcurrent conditions, and disconnecting the load when conditions exceed the trip curve's specifications. The software instructions execute these steps while enabling additional features like logging, dynamic trip curve selection, environmental adjustments, and user feedback.

This comprehensive design enables precise overcurrent protection, adaptability to diverse operating conditions, and seamless integration into modern power management systems.

One non-limiting object of the disclosure is the provision of a system for managing overcurrent conditions in a power line load by incorporating real-time monitoring, processing, and control.

In another and/or alternative non-limiting object of the disclosure is the provision of a system for managing overcurrent conditions in a power line load that enables precise overcurrent protection, adaptability to diverse operating conditions, and seamless integration into modern power management systems.

In another and/or alternative non-limiting object of the disclosure is the provision of a system for managing overcurrent conditions in a power line load that uses a current sensor to measure the electrical current applied to the load and a processor to evaluate the measured current against pre-established thresholds.

In another and/or alternative non-limiting object of the disclosure is the provision of a system for managing overcurrent conditions in a power line load that uses trip curve data stored in a memory to enables a processor to determine when the current exceeds safe operating levels and to optionally initiate a timer to track the duration of the overcurrent condition.

In another and/or alternative non-limiting object of the disclosure is the provision of a system for managing overcurrent conditions in a power line load that determines whether the current exceeds both the specified magnitude and duration defined by a trip curve, and if so, the processor sends a control signal to disconnect the load.

In another and/or alternative non-limiting object of the disclosure is the provision of a system for managing overcurrent conditions in a power line load that can dynamically adjust the pre-established threshold values based on environmental factors such as, but not limited to, ambient temperature, ambient pressure, and/or ambient humidity, thus facilitating in reliable operation under varying ambient conditions.

In another and/or alternative non-limiting object of the disclosure is the provision of a system for managing overcurrent conditions in a power line load includes the use of a relay that is operatively coupled to a processor, and wherein the processor enables precise load disconnection when unsafe conditions are detected.

In another and/or alternative non-limiting object of the disclosure is the provision of a system for managing overcurrent conditions in a power line load that diagnoses and/or monitors one or more system parameters such as, but not limited to, current values, timer durations, and/or disconnection events.

In another and/or alternative non-limiting object of the disclosure is the provision of a system for managing overcurrent conditions in a power line load that includes one or more predefined trip curves that can be used by a processor to select an appropriate curve based on the specific characteristics of the connected load.

In another and/or alternative non-limiting object of the disclosure is the provision of a system for managing overcurrent conditions in a power line load that supports user interaction and status feedback through use of a user interface, which user interface can include one or more displays used to display real-time current measurements, timer status, and/or whether the load has been disconnected.

In another and/or alternative non-limiting object of the disclosure is the provision of a system for managing overcurrent conditions in a power line load that can be configured to automatically reset a timer and reconnect a load once the current returns to a safe level for a predefined recovery period.

In another and/or alternative non-limiting object of the disclosure is the provision of a system for managing overcurrent conditions in a power line load can be partially or fully implemented by use of software instructions that are stored on a non-transitory computer-readable medium.

In another and/or alternative non-limiting object of the disclosure is the provision of an intelligent circuit breaker system comprising: a) a current sensor that is configured to measure electrical current applied to a power line load; b) a memory storing trip curve data corresponding to a trip curve of an associated circuit breaker; c) a processor that is configured to receive a measured current value from the current sensor; and wherein the processor is further configured to compare the measured current valve by the current sensor with a pre-established threshold value; and wherein when the measured current value exceeds a pre-established threshold value, the processor further is configured to i) start a timer, ii) determine whether a time duration from the start of the timer, and iii) disconnect the load when the measured current value exceeds a level and duration specified by the trip curve data.

In another and/or alternative non-limiting object of the disclosure is the provision of an intelligent circuit breaker system wherein the processor is further configured to adjust the pre-established threshold value based on one or more environmental factors; the environmental factors include one or more factors selected from the group consisting of ambient temperature, ambient pressure, and ambient humidity.

In another and/or alternative non-limiting object of the disclosure is the provision of an intelligent circuit breaker system further comprising a relay operatively coupled to the processor, and wherein the processor is configured to send a control signal to the relay to disconnect the load when the measured current value exceeds the level and duration specified by the trip curve data.

In another and/or alternative non-limiting object of the disclosure is the provision of an intelligent circuit breaker system wherein the processor is further configured to log in a data storage for diagnostic or monitoring purposes one or more of the measured current value, timer duration, and/or disconnection events.

In another and/or alternative non-limiting object of the disclosure is the provision of an intelligent circuit breaker system wherein the trip curve data stored in the memory includes multiple predefined trip curves; the processor is configured to select an appropriate trip curve based on the type of load connected to the power line.

In another and/or alternative non-limiting object of the disclosure is the provision of an intelligent circuit breaker system further comprising a user interface configured to display one or more of real-time current values, the status of the timer, and/or whether the load has been disconnected.

In another and/or alternative non-limiting object of the disclosure is the provision of an intelligent circuit breaker wherein the processor is further configured to reset the timer and reconnect the load automatically when the measured current value falls below the pre-established threshold value for a predefined recovery period.

In another and/or alternative non-limiting object of the disclosure is the provision of a method for managing overcurrent conditions in an intelligent circuit breaker system comprising: a) measuring electrical current applied to a power line load using a current sensor; b) storing trip curve data corresponding to a trip curve of an associated circuit breaker in a memory; c) receiving a measured current value from the current sensor; d) comparing the measured current value with a pre-established threshold value; and e) disconnecting the load when the measured current value exceeds a level and duration specified by the trip curve data.

In another and/or alternative non-limiting object of the disclosure is the provision of a method for managing overcurrent conditions in an intelligent circuit breaker system further comprising starting a timer when the measured current value exceeds the pre-established threshold value and monitoring the duration of the overcurrent condition.

In another and/or alternative non-limiting object of the disclosure is the provision of a method for managing overcurrent conditions in an intelligent circuit breaker system wherein the trip curve data includes multiple predefined trip curves; the method further comprises selecting a specific trip curve based on the type of load connected to the power line.

In another and/or alternative non-limiting object of the disclosure is the provision of a method for managing overcurrent conditions in an intelligent circuit breaker system further comprising logging in a storage module for diagnostic purposes one or more of the measured current value, duration of the overcurrent condition, and/or load disconnection events.

In another and/or alternative non-limiting object of the disclosure is the provision of a method for managing overcurrent conditions in an intelligent circuit breaker system further comprising adjusting the pre-established threshold value dynamically based on one or more environmental factors; the environmental factors include one or more factors selected from the group consisting of ambient temperature, ambient pressure, and ambient humidity.

In another and/or alternative non-limiting object of the disclosure is the provision of a method for managing overcurrent conditions in an intelligent circuit breaker system further comprising reconnecting the load automatically when the measured current value falls below the pre-established threshold value for a predefined recovery period.

In another and/or alternative non-limiting object of the disclosure is the provision of a method for managing overcurrent conditions in an intelligent circuit breaker system further comprising displaying one or more real-time current values, timer status, and/or disconnection status on a user interface.

In another and/or alternative non-limiting object of the disclosure is the provision of a non-transitory computer-readable medium containing instructions that, when executed by a processor, causes the processor to: a) receive a current value measured by a current sensor; b) compare the measured current value with a pre-established threshold value; c) start a timer when the measured current value exceeds the pre-established threshold value; and d) disconnect the load when the measured current value exceeds a level and duration specified by trip curve data stored in a memory.

In another and/or alternative non-limiting object of the disclosure is the provision of a non-transitory computer-readable medium containing instructions wherein the instructions further cause the processor to log into a storage module for later analysis one or more of the measured current values, timer durations, and/or disconnection events.

In another and/or alternative non-limiting object of the disclosure is the provision of a non-transitory computer-readable medium containing instructions wherein the instructions further cause the processor to dynamically select a trip curve from multiple predefined trip curves stored in the memory that is based on the type of load connected to the power line.

In another and/or alternative non-limiting object of the disclosure is the provision of a non-transitory computer-readable medium containing instructions wherein the instructions further cause the processor to update the pre-established threshold value based on information from environmental sensor data; the environmental senor data including data of one or more ambient temperature, ambient pressure, and ambient humidity.

In another and/or alternative non-limiting object of the disclosure is the provision of a non-transitory computer-readable medium containing instructions wherein the instructions further cause the processor to display one or more of real-time current values, overcurrent durations, and/or disconnection statuses on a user interface.

In another and/or alternative non-limiting object of the disclosure is the provision of a non-transitory computer-readable medium containing instructions wherein the instructions further cause the processor to automatically reset the timer and reconnect the load when the current value falls below the pre-established threshold for a predefined recovery period.

These and other advantages will become apparent to those skilled in the art upon the reading and following of this description.

### BRIEF DESCRIPTION OF THE DRAWINGS

Non-limiting and non-exhaustive embodiments are described with reference to the following drawings, wherein like labels refer to like parts throughout the various views unless otherwise specified. The sizes and relative positions of elements in the drawings are not necessarily drawn to scale. For example, the shapes of various elements are selected, enlarged, and positioned to improve drawing legibility. The particular shapes of the elements as drawn have been selected for ease of recognition in the drawings. Reference may now be made to the drawings, which illustrate various embodiments that the disclosure may take in physical form and in certain parts and arrangement of parts wherein:

FIG. 1 is a flowchart of an example embodiment of a power distribution management system for supplying on-demand devices;

FIG. 2 is an example embodiment of a power distribution management system that functions to provide power to corded tools while concurrently providing power to battery chargers;

FIG. 3 is a circuit diagram for an example embodiment of a power distribution management system that functions to selectively provide power to either power tools or battery chargers;

FIG. 4 is an example embodiment of a power distribution management system controller;

FIG. 5 is a graphical illustration of circuit breaker trip curve categories;

FIG. 6 is a an example embodiment of a trip curve graph;

FIG. 7 is an example embodiment of a system for overcurrent protection using dynamic trip curve evaluation. dynamic trip curve breaker; and

FIG. 8 a flowchart for an example embodiment of a system and method for overcurrent protection using dynamic trip curve evaluation.

### DETAILED DESCRIPTION OF THE DISCLOSURE

A more complete understanding of the articles/devices, processes and components disclosed herein can be obtained by reference to the accompanying drawings. These figures are merely schematic representations based on convenience and the ease of demonstrating the present disclosure, and are, therefore, not intended to indicate relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawings and are not intended to define or limit the scope of the disclosure. In the drawings and the following description below, it is to be understood that like numeric designations refer to components of like function.

The singular forms “a,” “an,” and “the” include plural referents unless the context clearly dictates otherwise.

As used in the specification and in the claims, the term “comprising” may include the embodiments “consisting of and “consisting essentially of” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any unavoidable impurities that might result therefrom, and excludes other ingredients/steps.

Numerical values in the specification and claims of this application should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of “from 2 inches to 10 inches” is inclusive of the endpoints, 2 inches and 10 inches, and all the intermediate values).

The terms “about” and “approximately” can be used to include any numerical value that can vary without changing the basic function of that value. When used with a range, “about” and “approximately” also disclose the range defined by the absolute values of the two endpoints, e g. “about 2 to about 4” also discloses the range “from 2 to 4.” Generally, the terms “about” and “approximately” may refer to plus or minus 10% of the indicated number.

Various non-limiting embodiments of the present disclosure will now be described to provide an overall understanding of the principles of the structure, function, and use of the apparatus, systems and methods disclosed. Those of ordinary skill in the art will understand that apparatus, systems and methods specifically described herein and illustrated in the accompanying drawings are non-limiting embodiments. The features illustrated or described in connection with one non-limiting embodiment may be combined with the features of other non-limiting embodiments. Such modifications and variations are intended to be included within the scope of the present disclosure. Any failure to specifically describe a combination or sub-combination of components should not be understood as an indication that any combination or sub-combination is not possible.

It will be appreciated that modifications to disclosed and described examples, arrangements, configurations, components, elements, apparatuses, devices, systems, methods, etc. can be made and may be desired for a specific application. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

Some portions of the detailed description herein are presented in terms of algorithms and symbolic representations of operations on data bits performed by conventional computer components, including a central processing unit (CPU), memory storage devices for the CPU, and connected display devices. These algorithmic descriptions and representations are the means used by those skilled in the data processing arts to most effectively convey the substance of their work to others skilled in the art. An algorithm is generally perceived as a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be understood, however, that all of these and similar terms are to be associated with the appropriate physical quantities and are merely convenient labels applied to these quantities. Unless specifically stated otherwise, as apparent from the discussion herein, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The exemplary embodiment also relates to an apparatus for performing the operations discussed herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the methods described herein. The structure for a variety of these systems is apparent from the description above. In addition, the exemplary embodiment is not described with reference to any particular programming language. It will be appreciated that a variety of programming languages may be used to implement the teachings of the exemplary embodiment as described herein.

A machine-readable medium includes any mechanism for storing or transmitting information in a form readable by a machine (e.g., a computer). For instance, a machine-readable medium includes read only memory (“ROM”); random access memory (“RAM”); magnetic disk storage media; optical storage media; flash memory devices; and electrical, optical, acoustical or other form of propagated signals (e.g., carrier waves, infrared signals, digital signals, etc.), just to mention a few examples.

The methods illustrated throughout the specification, may be implemented in a computer program product that may be executed on a computer. The computer program product may comprise a non-transitory computer-readable recording medium on which a control program is recorded, such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other tangible medium from which a computer can read and use.

The systems and methods disclosed herein are described in detail by way of examples and with reference to the figures. It will be appreciated that modifications to disclosed and described examples, arrangements, configurations, components, elements, apparatuses, devices methods, systems, etc. can suitably be made and may be desired for a specific application. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such.

Certain power management situations include on-demand devices, such as appliances or power tools, along with deferred use devices, such as battery chargers, which are fed by a shared power circuit. While power may be interrupted for deferred use devices, on-demand devices may require continuous power access. The shared power circuit has a power supplying capacity threshold. This threshold may be associated with a fuse or circuit breaker for the shared circuit. A threshold may also be associated with a maximum power output by a generator, such as a gasoline or diesel generator that provides AC power to devices via an inverter.

A smart power strip includes multiple power outlets, each controlled by an individual switch and managed by a central controller. The controller repeatedly measures or estimates the total current passing through the strip, comparing it against a prescribed threshold that is set below the rating of an upstream breaker or fuse. If the total current exceeds that threshold, the controller identifies which outlet caused the surge and selectively turns off only that one outlet, avoiding a full power shutdown of all devices. The outlet is automatically reconnected when conditions allow (for example, after the load decreases or after a timed delay). The concept can also be expanded by chaining several Smart Power Strips together in a “primary-secondary-tertiary” arrangement, in which the primary strip coordinates overall current management across all connected strips. This approach prevents overloads at the system level while maintaining power to as many outlets as possible.

An example embodiment herein features a smart circuit breaker installed within an electrical panel that continually measures current flowing through its protected circuit. As it operates, the breaker transmits real-time data about the present current draw, such as “14 amps out of a 20-amp circuit,” to a separate Power Distribution Module (PDM). This live data feed may be delivered through a wired connection, a wireless protocol, or a powerline communication channel. By broadcasting the measured current in near real time, the breaker gives the PDM a highly accurate view of how much headroom remains before the breaker's trip point is reached.

In other example embodiments, the smart breaker also provides updates on its actual trip threshold. This threshold may be fixed (for example, a nominal 20-amp limit) or may be adjustable under certain conditions, such as a demand-response program. If the breaker's trip setting is modified (e.g., lowered to 16 amps during peak utility load periods), the breaker notifies the PDM of the updated trip current. With this information, the PDM can account for the reduced capacity and avoid drawing more current than the circuit can support. Conversely, if the breaker reverts to a higher trip setting, the PDM can detect that additional current capacity is again available.

Upon receiving the ongoing current readings and any updated trip-current information from the breaker, the PDM analyzes whether its own attached loads, such as outlets powering tools, appliances, or other devices, can be safely maintained without causing an overload. If the PDM's load management algorithm determines that one or more connected outlets are pushing the circuit near or above the trip threshold, it selectively disconnects or staggers the activation of those outlets to prevent a nuisance trip. This selective shutdown occurs on a per-outlet basis, enabling only the necessary subload to be turned off while other outlets remain active.

When the overall current draw dips, for instance because a different load on the same breaker has turned off, the breaker's real-time measurements let the PDM know there is now additional current headroom. In response, the PDM can then automatically re-energize previously shed devices or power up new loads. Such continuous communication between the breaker and the PDM provides a dynamic feedback loop that maximizes available current usage while respecting protective limits. This arrangement thus enhances overcurrent protection, reduces the likelihood of full breaker trips, and gives users a more efficient and automated approach to managing electrical loads.

Example embodiments herein prioritize delivery of power to critical devices over non-critical devices, such as battery chargers. Examples of critical devices that professionals may use in the field include

Power Tools: Drills, saws, grinders, nail guns, and other electric tools that are actively being used for construction, repair, or landscaping tasks

Power Tools: Saws, drills, sanders, blowers, grinders, air compressors or nail guns

Medical Equipment: Portable medical devices such as ventilators, defibrillators, or diagnostic tools required in emergency or remote healthcare situations

Communication Devices: Radios, satellite phones, or portable routers essential for maintaining communication in remote locations or during emergencies

Lighting Systems: Portable work lights, floodlights, or safety lighting that ensure visibility and safety in dark or low-light conditions

Pumps: Water pumps or dewatering equipment used in landscaping, construction, or disaster response scenarios

Measuring and Surveying Equipment: Devices such as laser levels, total stations, or GPS systems used for precision tasks in construction or surveying

Welding Equipment: Portable welders or soldering devices necessary for on-site fabrication or repair work

Cutting Equipment: Electric or battery-powered chainsaws, hedge trimmers, or pruning tools commonly used by landscapers or arborists

Portable Refrigeration Units: Cooling systems for storing temperature-sensitive materials, such as food or medical supplies, during field operations

Safety Systems: Fans or air circulation devices to ensure safe working conditions in confined or hazardous spaces.

Portable Computers: Laptop computers, tablets, smart phones, etc.

These critical devices typically have higher priority because their operation directly impacts productivity, safety, or the ability to complete tasks in the field effectively.

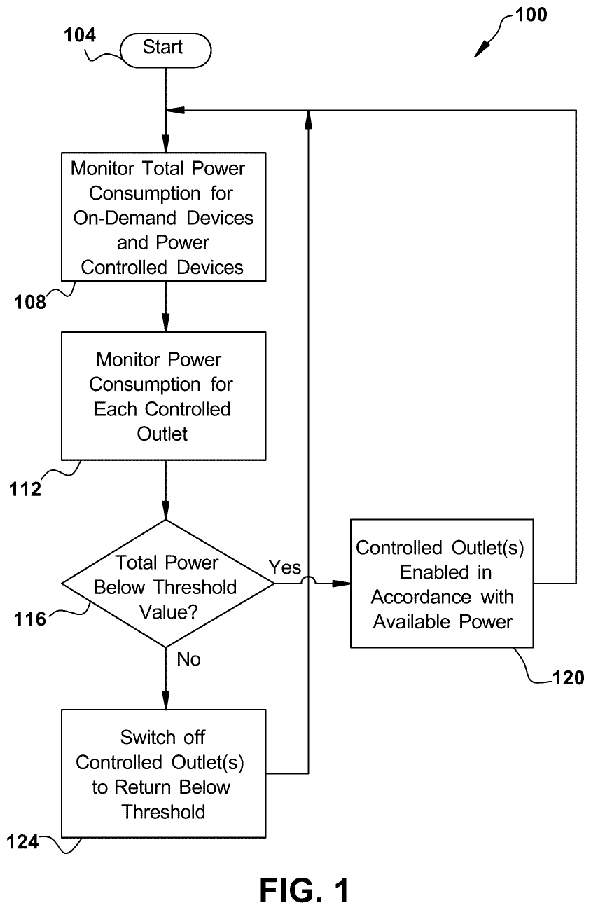

FIG. 1 illustrates a flowchart 100 of an example embodiment of a PDM system for supplying on-demand devices, such as corded power tools, and deferred demand devices, such as battery chargers. The system commences at block 104 and proceeds to block 108 where a total power consumption for on-demand devices and power controlled devices is monitored. Next, power consumption is monitored for each controlled outlet at block 112. A test is made at block 116 to determine whether total power consumed is below a threshold value. If so, all controlled outlets are enabled at block 120 and the system returns to block 108. If the total power is above the threshold, one or more controlled power outlets are turned off at block 124 to return total power below the threshold value.

In the example embodiment of FIG. 1, a determination as to which outlet, or outlets, are switched off is suitably made based on a difference between the threshold value and current power consumption as compared to power drawn by individual devices. One or more devices are switched off to take the total load below the threshold value. This decision may simply be a “best fit” option. A decision may also be made on interrupting the fewest devices to accomplish the required current draw reduction. Other options are suitably used to determine which outlets are to be switched off:

Greatest Recent Surge (Actively Running vs. Charging)

Example: A landscaper has a high-power electric hedge trimmer plugged in and running. Meanwhile, two cordless tool chargers (for a leaf blower and a chainsaw) are also connected. When the landscaper kicks on a shop vacuum to clean up clippings, the total current draw spikes above the threshold.

Decision: The system identifies that the vacuum caused the sharpest surge in current. However, the vacuum is actively needed for immediate cleanup, whereas the chargers are only replenishing batteries. The PDM switches off one or both chargers, freeing up enough current capacity so the hedge trimmer and the vacuum can run simultaneously without tripping the breaker.

Outcome: The trimmer and vacuum remain powered (both in active use), while the chargers pause briefly. Once the vacuum finishes, the system detects lower load and automatically re-energizes the chargers.

Priority-Based Shutoff (Active Work vs. Idle Charging)

Example: A landscaping team uses several battery-powered tools, hedge trimmers, leaf blowers, weed whackers, that each have dedicated chargers. The same smart power strip also has an outlet powering a portable air compressor for inflating tires and a second outlet powering lights. The user tags the lights and compressor as “High Priority” (vital for safety and mobility) while ranking chargers as “Low Priority.”

Decision: If total current surges (e.g., the air compressor cycles on while the lights are illuminated), the system first looks at lower-priority devices, in this case, the tool chargers. It turns off one or more chargers to ensure the lights remain on and the compressor can run.

Outcome: Essential functions (lighting and air compressor) stay up and running. The chargers simply resume once the compressor shuts off or the total current falls back below the threshold.

Load Shedding by Detecting Active vs. Passive Tools

Example: Multiple cordless blowers and trimmers are on charge, but only one is actively being used. The user decides to also power an electric chainsaw from the strip. The chainsaw's motor surges the current draw well above the limit.

Decision: The system detects that several tools are simply charging and have no immediate usage. In contrast, the chainsaw is actively running (high priority). It shuts off some or all of the charging tools particularly any that are near a full charge, to instantly drop below the threshold.

Outcome: The chainsaw continues to operate seamlessly. Once the operator finishes cutting, the system sees a lower overall load and restarts the chargers automatically.

User-Defined Scheduling (High-Draw vs. Low-Draw Landscaping Equipment)

Example: The landscaper has a small electric stump grinder and a battery charger for a heavy-duty hedge trimmer. Both can draw significant current. The smart power strip is configured so that the stump grinder (a major load) only runs alone, while all chargers wait until the grinder is switched off or ramps down.

Decision: If the user tries to run the stump grinder while the hedge trimmer charger is actively pulling a high charge current, the system senses an overload risk. It either delays the charger or shuts it off until the grinder's load stabilizes.

Outcome: The stump grinder operates uninterrupted, avoiding a circuit trip. The hedge trimmer resumes charging immediately after the grinder no longer needs peak power.

### Adaptive Monitoring for Intermittent High-Power Tools

Example: A landscaper connects multiple battery chargers and occasionally uses a high-wattage pressure washer to clean off mowers or vehicles. The washer draws large current surges when triggered.

Decision: Once the washer's trigger is pulled, the smart strip detects a sudden spike that could exceed the threshold. Recognizing that the washer is in active use (i.e., a high priority), it automatically shuts down the chargers for the cordless mowers or trimmers.

Outcome: The pressure washer continues uninterrupted during active cleaning, ensuring it does not trip the breaker. Once the user releases the washer's trigger or finishes cleaning, the system sees the current drop and reactivates the chargers so the landscaping tools can resume charging.

In each scenario, the PDM logic prioritizes tools in immediate use, such as a trimmer, pressure washer, or hedge cutter, while temporarily deactivating lower-priority chargers or devices that can wait. This ensures continuous workflow for the operator and prevents breaker trips that would halt all devices at once.

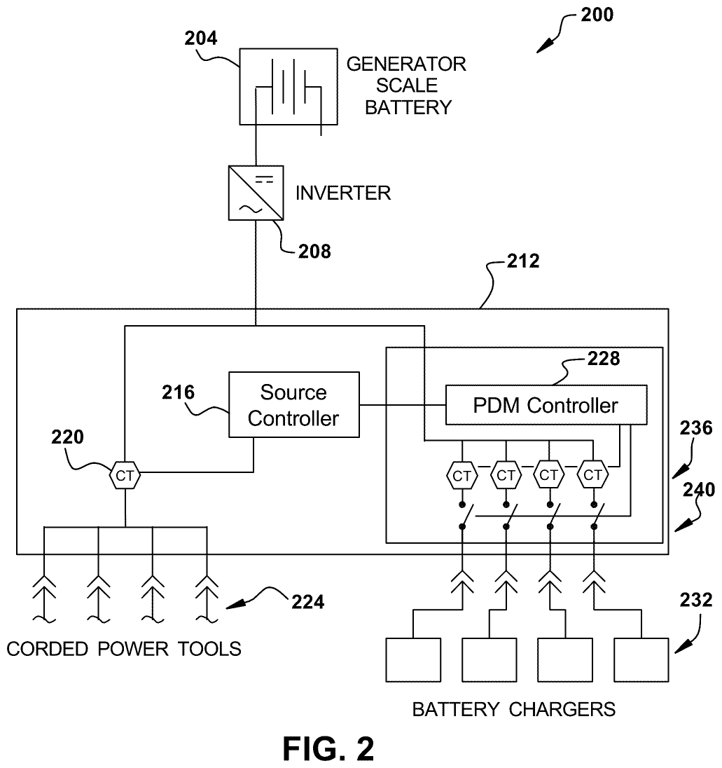

FIG. 2 illustrates a circuit diagram 200 for an example embodiment of a power distribution management system that functions to provide power to corded tools while concurrently providing power to battery chargers. Power, suitably DC power, is supplied by generator scale battery 204. A generator-scale battery is a large-scale energy storage system designed to function alongside, or as an alternative to, traditional power generators. These batteries store substantial amounts of energy, allowing them to supply power for extended periods or deliver significant power output instantly on demand. They are typically used in backup power systems, grid stabilization, or hybrid configurations, where they can work with traditional generators to reduce fuel consumption and emissions by operating the generator only when necessary.

These batteries are characterized by their high energy capacity, scalability, and ability to handle frequent charging and discharging cycles. They are robust and suitable for industrial and large-scale applications. Generator-scale batteries are often used as backup power sources for critical systems such as hospitals, data centers, or manufacturing facilities. They can also support peak shaving, where energy is stored during off-peak times and used during peak demand to reduce electricity costs. In renewable energy setups, these batteries store energy from sources like solar or wind to provide power when generation is low or demand is high. Additionally, they are used for grid stabilization by absorbing excess energy when supply exceeds demand and discharging it when demand outpaces supply. In remote or off-grid areas, they store energy generated from renewable sources, reducing or eliminating the need for fossil-fuel generators.

Examples of generator-scale batteries include the Tesla Megapack, CAT Energy Storage systems, and Fluence Gridstack. These systems are often integrated with traditional generators to create hybrid setups, reducing emissions and fuel usage. They offer several advantages over traditional generators, including fuel-free operation, quiet and clean energy delivery, faster response times, and lower maintenance needs.

A generator-scale battery in the landscaping industry serves as a large-scale energy storage system that can power or supplement traditional generators used for landscaping equipment. These batteries are capable of storing and delivering substantial amounts of energy to operate high-demand tools like electric chainsaws, trimmers, blowers, and mowers. By providing reliable and portable power, they enable landscapers to work efficiently without relying entirely on gas or diesel-powered generators.

Landscapers can use generator-scale batteries to charge cordless tool batteries or directly power tools and machinery. For example, when operating in remote locations, a generator-scale battery can store energy from an on-site renewable source, such as portable solar panels, or be pre-charged for use in the field. These systems can prioritize active tools over idle or charging devices, ensuring that high-demand equipment like electric mowers or trimmers receive uninterrupted power while pausing lower-priority loads, such as chargers or less critical tools, during peak usage.

Generator-scale batteries are particularly beneficial for reducing noise and emissions in residential or noise-sensitive areas, where traditional gas generators may not be suitable. Their quiet operation allows landscapers to work without disturbing clients or violating local noise ordinances. Additionally, they offer instant power delivery, allowing landscapers to switch between devices seamlessly without the delays associated with starting and stopping a generator.

In hybrid setups, a generator-scale battery can be paired with a small generator to optimize fuel use. The generator can recharge the battery during downtime, while the battery provides primary power during operation. This reduces fuel costs and wear on the generator while maintaining a steady power supply for landscaping tools. Challenges include the higher upfront cost of the battery system and the need for careful load management to avoid depleting the stored energy prematurely.

DC power from generator scale battery 204 is fed to inverter 208. A DC power inverter converts direct current electricity, typically from sources like batteries, solar panels, or fuel cells, into alternating current (AC) electricity, which is the standard form of power used by most household appliances and electrical systems. The inverter enables the operation of AC-powered devices in environments where only DC power is available, such as in off-grid solar systems, vehicles, or portable power setups. It achieves this by using electronic circuits to modify the flow of DC electricity, creating a waveform that mimics the alternating nature of AC power, often at specific voltages and frequencies, for example 120V/60 Hz in the United States and 230V/50 Hz in Europe.

AC power from inverter 208 is fed to power management system (PMS) 212, into source controller 216. Source controller 216 manages and regulates a flow of power from inverter 208 to downstream components in PMS 212. It ensures that power is efficiently distributed to various connected devices, including current transformers, tools, and battery chargers, while preventing overloading or inefficiencies. Source controller 216 monitors an overall power demand and dynamically adjusts the allocation of energy to prioritize critical devices and balance loads. It suitably includes features for fault detection, overcurrent protection, and communication with other system controllers, such as other power distribution modules. Source controllers are commonly used in industrial, renewable energy, and portable power systems to optimize energy use and maintain safe, stable operation.

Source controller 216 feeds current transformer (CT) 220. CT 220 functions to measure circuit current and provide a scaled-down, proportional current signal to monitoring or protection equipment. CT 220 measures and monitors current flow, calculates power usage, and supplies data relative to detected faults or overloads and so as to trigger circuit breakers or control switches when needed. Alerts are suitably generated when one or more loads have been disconnected, such as by generating an alert, alarm or a visual indicator, such as a light, that indicates whether a particular outlet is enabled or disabled. It also provide electrical isolation between a high-current primary circuit and a low-current secondary circuit to ensure safety and compatibility for monitoring. By scaling high currents to manageable levels, current transformers enable accurate measurement, control, and protection in power systems. CT 220, in turn, provides power to one or more power tools.

Source controller 216 also feeds PDM controller 228 which provides power to one or more battery chargers 232 via a corresponding CT in a series of CTs 236 and a corresponding controllable switches in a series of breakers 240 which are configured to cooperatively calculate available current and set a threshold current in the PDM controller accordingly. This functions to keep a total current below a current limit of inverter 208.

Controllable switches suitably used to connect or disconnect specific loads, such as battery chargers or power tools, are based on system requirements. A type of switch used depends on factors like voltage, current, response time, and efficiency. Electromechanical relays are one option, operated by an electromagnetic coil and capable of handling high currents, but they have slower response times and are prone to wear over time due to their moving parts. Solid-state relays use semiconductors instead of mechanical components, offering faster response times and longer lifespans, which makes them ideal for applications requiring frequent switching. MOSFETs provide high-speed, low-loss switching for DC circuits, with excellent efficiency and suitability for battery management systems. For higher-voltage or higher-current applications, IGBTs are often chosen because they combine the fast switching characteristics of MOSFETs with the power-handling capabilities of bipolar transistors. Thyristors and triacs are commonly used for controlling AC power, with thyristors handling high-current loads and triacs enabling bidirectional power control, making them suitable for managing AC loads like battery chargers. Relay modules with built-in control circuits are suitable, simplifying integration with microcontrollers or other components. Advanced smart switches or circuit breakers, which incorporate monitoring and communication features, are suitable for such intelligent power management systems.

Non-critical systems, such as battery charges, can be reconnected as power consumption drifts below the threshold value. Outlets can be reconnected based on historical levels of power consumed by that outlet relative to how much capacity is regained relative to the threshold value. By way of example, if 4 amps become available below a current threshold value, one or more outlets that drew an aggregate of 4 amps prior to cutoff can be restored. T

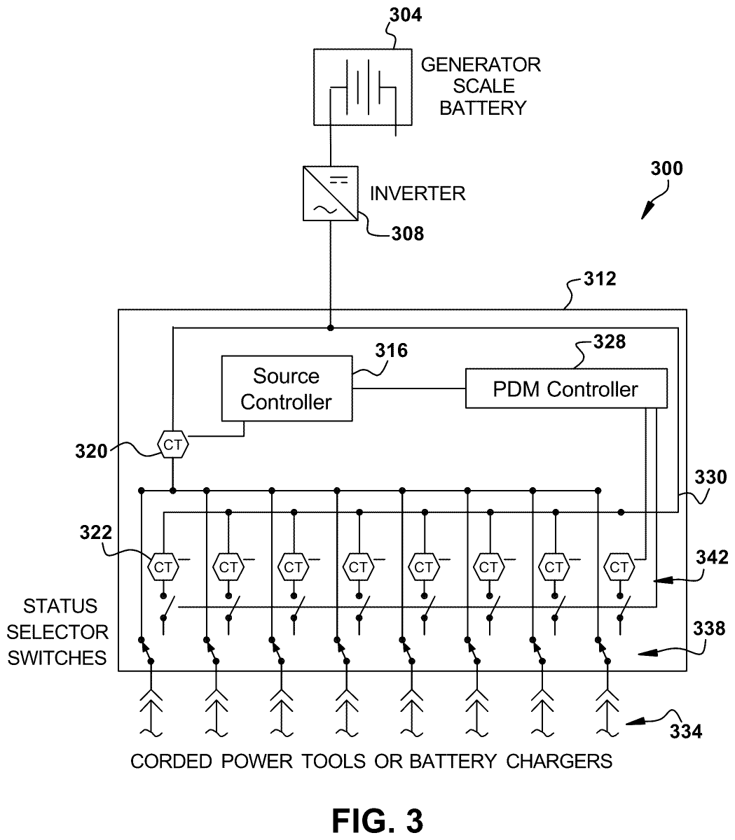

FIG. 3 illustrates a circuit diagram 300 for an example embodiment of a power distribution management system that functions to selectively provide power to either power tools or battery chargers. In this example embodiment, any outlet can accommodate a power tool or a battery charger, and a selector switch is engaged for each outlet to specify which one is present. Generator scale battery 304 feeds DC power to inverter 308, which in turn feeds AC power to PDM system 312 via source controller 316. Source controller 316 supplies power to CT 320 which, in turn, supplies power to corded power tool supply line 322.

Source controller 316 also supplies power to PDM controller 328 which, in turn, supplies power to battery charger supply line 330. Each device supply line or outlet 334 is fed by one of a series of controllable selector switches 338 that specify whether an associated outlet is to be fed from power tool supply line 322 or battery charger supply line 330. When a battery charger is selected, connection to each charge is via one of an associated series of CTs 342. Accordingly, source controller 316 communicates available current updates based on always on (power tool) outlets to PDM controller 328. PDM controller 328 relays battery charger status lines to on or off to keep a total current below a threshold limit associated with inverter 308.

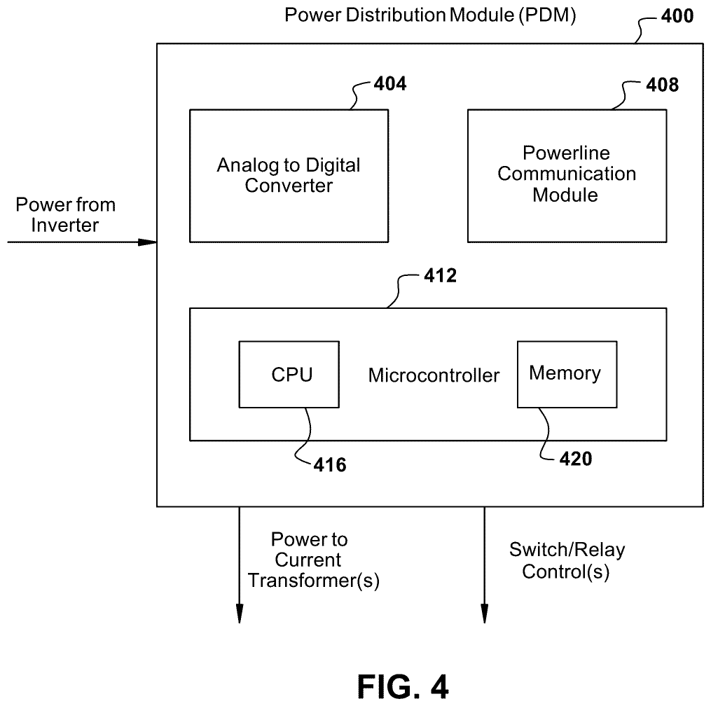

FIG. 4 illustrates an example embodiment of a PDM controller 400. Included is an analog to digital converter 404, powerline communications module 408 and microcontroller 412. Microcontroller 412 includes one or more CPUs, such as CPU 416 and volatile or non-volatile data storage, illustrated by memory 420.

PDM controller 400 provides efficient energy allocation monitors power from an inverter and ensures uninterrupted power supply to essential devices like power tools, while dynamically managing interruptible power for battery chargers. The system includes analog-to-digital converter (ADC) 404 to measure and digitize electrical signals, enabling precise monitoring of current and voltage levels across the system. Powerline communication module 408 functions to provide communication between an inverter, controllers, and connected devices over the powerline infrastructure, reducing the need for separate communication wiring. The microcontroller serves as the central processor, coordinating real-time decisions based on data collected from the ADC and other sensors.

In operation, the system continuously monitors the total current being drawn from the inverter and the current consumed by each battery charger line. When the overall current approaches the inverter's set threshold, the microcontroller identifies which battery chargers can be temporarily disconnected without impacting critical operations. Using this prioritization, the system selectively disconnects chargers to keep the total current below the threshold, ensuring stable operation of power tools and other high-priority devices. Once the load decreases, the microcontroller selectively reconnects the chargers based on their demand and availability.

Operation of the PDM controller in the example embodiment dynamically adjusts individual power outlets based on both shared and individual current measurements to ensure that the total power consumption remains within acceptable limits. This code is written in Arduino's open source variant of C/C++. Arduino programming language is based on C/C++ and provides a simplified interface for working with hardware. It utilizes C/C++ syntax along with additional libraries and functions specific to the Arduino platform. The example code dynamically adjusts individual power outlets based on both shared and individual current measurements to ensure that the total power consumption remains within acceptable limits as follows:

```
  const int numOutlets = 4; // Number of outlets
  const int sharedCurrentPin = A0; // Analog pin connected to the shared current sensor
  const int individualCurrentPin[numOutlets] = {A1, A2, A3, A4}; // Analog pins connected
to individual current sensors
  const int relayPin[numOutlets] = {2, 3, 4, 5}; // Digital pins connected to SSRs
  const float initialThreshold = 20.0; // Initial total power threshold in amps
  const float sharedThreshold = 15.0; // Threshold for shared current
  float individualThreshold = initialThreshold / numOutlets; // Threshold for individual
outlets
  void setup( ) {
    // Initialize serial communication
    Serial.begin(9600);
    // Set relay pins as outputs
    for (int i = 0; i < numOutlets; i++) {
      pinMode(relayPin[i], OUTPUT);
      digitalWrite(relayPin[i], HIGH); // Initially turn on all relays
    }
  }
  void loop( ) {
    float sharedCurrent = readSharedCurrent( );
    float individualCurrent[numOutlets];
    float remainingThreshold = initialThreshold;
    // Read individual current from each outlet
    for (int i = 0; i < numOutlets; i++) {
      individualCurrent[i] = readIndividualCurrent(i);
    }
    // Calculate remaining available power after considering individual currents
    for (int i = 0; i < numOutlets; i++) {
      if (individualCurrent[i] > individualThreshold) {
        remainingThreshold -= individualCurrent[i];
      }
    }
    // Check if shared current exceeds the threshold
    if (sharedCurrent > sharedThreshold) {
      // Determine which outlets need to be disabled
      for (int i = 0; i < numOutlets; i++) {
        if (individualCurrent[i] > individualThreshold) {
          digitalWrite(relayPin[i], LOW); // Turn off relay for this outlet
        } else {
          digitalWrite(relayPin[i], HIGH); // Turn on relay for this outlet
        }
      }
      Serial.println(″Shared current threshold exceeded. Adjusting outlets.″);
    } else {
      // Re-enable outlets up to the extent of remaining available power
      for (int i = 0; i < numOutlets; i++) {
        if (remainingThreshold > individualThreshold) {
          digitalWrite(relayPin[i], HIGH); // Turn on relay for this outlet
          remainingThreshold -= individualThreshold;
        } else {
          digitalWrite(relayPin[i], LOW); // Turn off relay for this outlet
        }
      }
      Serial.println(″Shared current within threshold. Adjusting outlets.″);
    }
    delay(1000); // Delay before next loop iteration
  float readSharedCurrent( ) {
    // Read analog value from shared current sensor
    int sensor Value = analogRead(sharedCurrentPin);
    // Convert analog value to current (adjust as per sensor calibration)
    float sharedCurrent = map(sensorValue, 0, 1023, 0, 20); // Assuming 0-20 amps range
    return sharedCurrent;
  }
  float readIndividualCurrent(int outletIndex) {
    // Read analog value from individual current sensor for the specified outlet
    int sensor Value = analogRead(individualCurrentPin[outletIndex]);
    // Convert analog value to current (adjust as per sensor calibration)
    float individualCurrent = map(sensorValue, 0, 1023, 0, 20); // Assuming 0-20 amps range
    return individualCurrent;
  }
```

This example code is suitable a microcontroller-based power management system that dynamically adjusts individual power outlets based on both shared and individual current measurements, while considering the available power remaining. The example code operates as follows:

It defines constants for the number of outlets (numOutlets), analog pins connected to a shared current sensor (sharedCurrentPin), analog pins connected to individual current sensors (individualCurrentPin), digital pins connected to solid-state relays (relayPin), initial total power threshold (initialThreshold), threshold for shared current (sharedThreshold), and calculates the threshold for individual outlets based on the initial threshold and number of outlets (individualThreshold).

In the setup( ) function:
It initializes serial communication for debugging purposes.
It sets the relay pins as outputs and initially turns on all relays.

In the loop( ) function:
It reads the shared current from the shared current sensor using the readSharedCurrent( ) function.
It reads individual currents from each outlet using the readlndividualCurrent( ) function.
It calculates the remaining available power after considering individual currents.
It checks if the shared current exceeds the threshold.
If the shared current exceeds the threshold, it individually checks each outlet's current consumption against the calculated individual threshold and disables the outlets accordingly,
If the shared current is within the threshold, it re-enables outlets up to the extent of the remaining available power.
It then delays for one second before the next iteration of the loop.

There are two helper functions:
readSharedCurrent( ): Reads the analog value from the shared current sensor and converts it to a current value.
readIndividualCurrent(int outletIndex): Reads the analog value from the individual current sensor for a specific outlet and converts it to a current value.

In summary, this code creates a power management system that dynamically adjusts individual power outlets based on shared and individual current measurements while considering the available power remaining, ensuring that the total power consumption remains within acceptable limits.

Circuit breakers serve as safety devices within electrical systems, designed to safeguard circuits against damage resulting from overcurrent, which may stem from overloads or short circuits. Their primary role is to interrupt the flow of electricity upon detecting an electrical fault, thereby mitigating potential hazards such as fires, equipment damage, or personal injury.

Circuit breakers operate automatically to disconnect electrical circuits when they detect conditions that could be harmful, such as excessive current flow. They achieve this through a combination of thermal and magnetic mechanisms. In thermal-magnetic breakers, the thermal part responds to prolonged overcurrent conditions, while the magnetic part reacts quickly to short circuits.

There are several types of circuit breakers, each suited to different applications. Miniature Circuit Breakers (MCBs) are used for low voltage applications, typically found in residential and commercial buildings. Molded Case Circuit Breakers (MCCBs) handle higher currents and are used in industrial settings. Ground Fault Circuit Interrupters (GFCIs) protect against ground faults, which occur when current leaks to the ground, posing a shock hazard. Arc Fault Circuit Interrupters (AFCIs) detect and interrupt arc faults, which are dangerous electrical discharges that can cause fires.

Unlike fuses, which must be replaced after they blow, circuit breakers can be reset after they trip, restoring the circuit to normal operation once the fault condition has been addressed. This resettable feature makes them more convenient and economical in the long run.

In various settings, including residential, commercial, and industrial environments, circuit breakers are used to protect electrical systems. They ensure the safe operation of electrical devices and prevent damage by cutting off power when abnormal conditions are detected. In summary, circuit breakers are critical components in electrical systems, providing protection and safety by automatically disconnecting circuits when dangerous overcurrent conditions are detected. They come in various types and are characterized by different trip curves to suit a wide range of applications, from residential homes to industrial facilities.

Circuit breakers are associated with trip curves which describe how the breaker responds to overcurrent conditions. Trip curves are essential for understanding the protection characteristics and ensuring the appropriate breaker is selected for the specific application.

A trip curve is a graphical representation showing the relationship between the current flowing through the breaker and the time it takes for the breaker to trip (disconnect). The x-axis represents the multiple of the rated current, while the y-axis represents the time to trip. Different types of circuit breakers have specific trip curves. For example, thermal-magnetic breakers, common in residential and light commercial applications, have trip curves showing two distinct regions: thermal (slow response to moderate overcurrents) and magnetic (fast response to high overcurrents). Electronic breakers, used in more advanced applications, have programmable trip curves offering more precise protection tailored to specific requirements. Motor protection breakers, designed for motor circuits, have trip curves that accommodate the high inrush currents typical of motor startup.

There are several basic categories of circuit breaker trip curves:
Z Curve: Trips at 2-3 times the rated current, for highly sensitive electronic devices and precision equipment.
B Curve: Trips at 3-5 times the rated current, suitable for resistive loads like lighting and heating.
C Curve: Trips at 5-10 times the rated current, used for general-purpose applications and mixed loads, including motors.
K Curve: Trips at 10-14 times the rated current, suitable for inductive loads with moderate inrush currents, such as transformers and certain lighting.
D Curve: Trips at 10-20 times the rated current, designed for highly inductive loads with high inrush currents, like large motors and transformers.

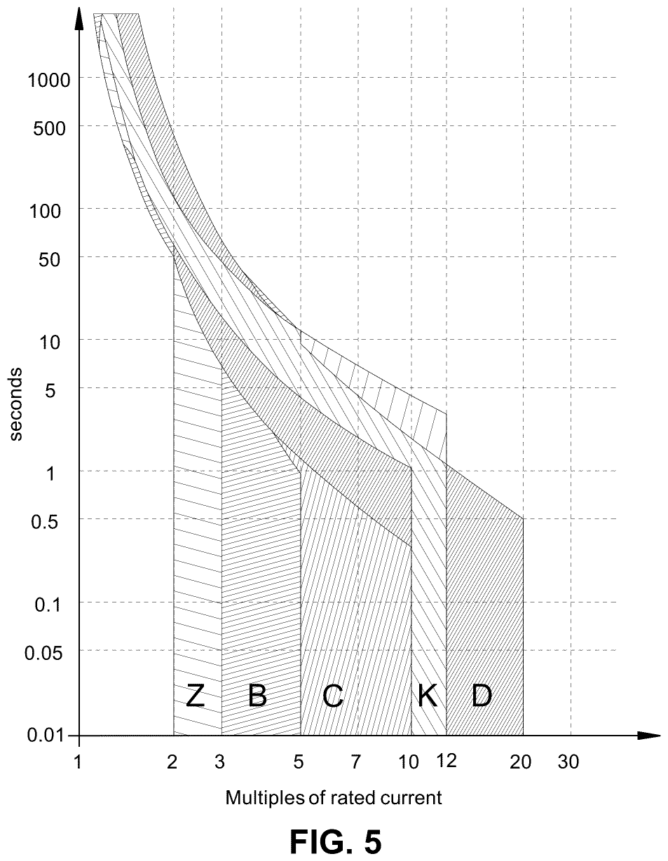

A graphical illustration of the trip breaker trip curve categories is shown in FIG. 5.

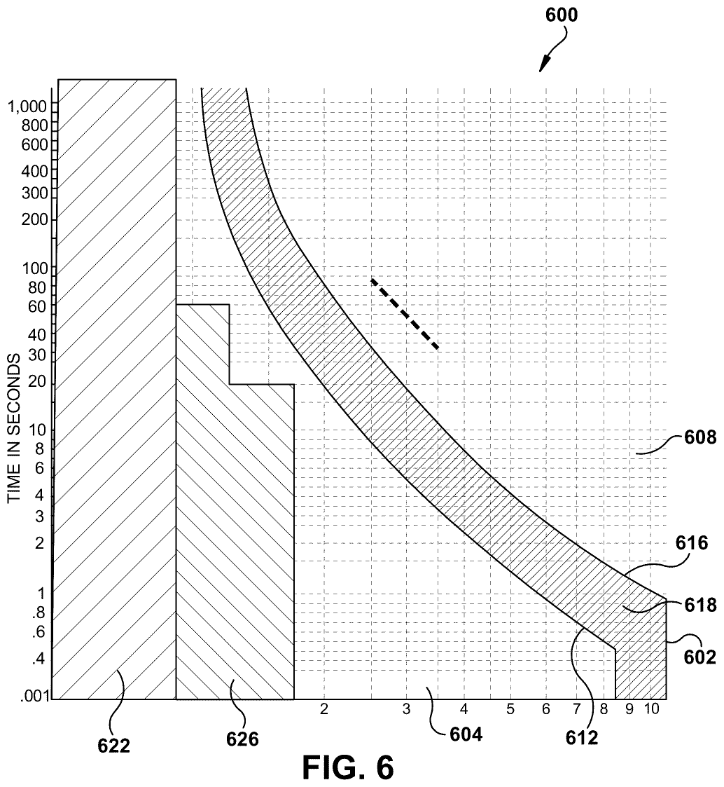

FIG. 6 illustrates an example embodiment of a trip curve graph 600. Trip curve 602 defines an open area 604 below the trip curve on a graph. This is commonly referred to as the non-tripping zone or the safe operating region. This area signifies the range of current and time combinations where the circuit breaker will not trip, indicating conditions that are safe for both the circuit and the load. When the system operates within this zone, the breaker remains in the closed (on) position, allowing normal current flow.

Non-tripping zone is 604 located below the trip curve line on a trip curve graph 600, illustrated current versus time graph. Within this area, current values might exceed the breaker's rated current, but only for durations too short to trigger a trip. These conditions often correspond to transient events such as inrush currents from motor startups or momentary surges from capacitive loads. The breaker tolerates these brief exceedances without disconnecting the circuit, ensuring the system continues to operate without unnecessary interruptions.

Trip curve 602 serves as the boundary between non-tripping zone 604 and tripping zone 608, which lies above the curve. The non-tripping zone represents the allowable limits of operation where the breaker permits current flow without interruption. In contrast, the tripping zone reflects conditions that exceed these limits and require the breaker to disconnect the circuit to protect against potential damage or hazards.

Trip curve 602 is defined by lower boundary 612 and upper boundary 616. Area 618 is disposed between them, defining a tolerance band or operational range for the circuit breaker. Area 618 accounts for variability in the breaker's tripping behavior under different conditions. Lower boundary 612 of the curve represents the minimum response threshold of the circuit breaker. Any combination of current and time that falls below this line will not cause the breaker to trip. This is the zone where the breaker is guaranteed to allow current flow, as the conditions are within the acceptable operating limits of the breaker.

Upper boundary 616 represents a maximum response threshold, where the breaker is guaranteed to trip. If the current and time combination exceeds this line, the breaker will disconnect the circuit without exception. This ensures that the system is protected from extreme overcurrent conditions that could lead to damage or safety hazards.

Area 618 between the two lines, often referred to as the zone of uncertainty or variability, is where the breaker's tripping behavior may vary. Within this zone, the breaker might trip, but it is not guaranteed to do so immediately. This variability arises due to tolerances in the breaker's components, manufacturing processes, and environmental factors like temperature or aging. The existence of this zone accounts for real-world variations and ensures the breaker is neither overly sensitive (causing nuisance trips) nor too lax (failing to provide protection). In practical terms, if the operating conditions fall below the lower line, the breaker will not trip. If the conditions rise above the upper line, the breaker will definitely trip. However, if the conditions are within the area between the two lines, the breaker's response will depend on factors such as the exact current level, duration, and even small variations in its mechanical or electronic components.

Vertical rectangular region 622 of trip curve graph 600 is a transient tolerance zone, momentary safe region, or asymptotic safe boundary. Its presence highlights the breaker's ability to handle short-lived high currents effectively, ensuring that protection is provided only when necessary while avoiding unnecessary interruptions. Trip curve 602 curve approaches region 622 asymptotically but never touches it, this region defines an immediate tolerance region or non-tripping boundary. This region represents current and time combinations that involve extremely short durations of high current levels. Even though the current may spike momentarily to levels that are significantly above the rated current, the duration is so brief that the breaker does not trip. This region is characterized by the trip curve approaching the boundary asymptotically. This means that, as the current increases, the breaker can tolerate those higher levels for shorter and shorter periods without tripping. The asymptotic behavior of the curve ensures that the breaker avoids responding to transient events such as inrush currents from motor startups or other momentary surges. These conditions are considered normal and not faults, so the breaker remains in the closed (on) position.

While nuissance tripping may be avoided by conditions in boundary 622, example embodiments herein further extend this boundary into area 626. Unlike boundary 622, which will never incounter a trip curve condition, conditions that fall within boundary 626 are limited by a combined influence of current level and time duration. Addition of area 626 is facilitated by example embodiments herein. One more additional boundary area is suitably added in non-tripping zone 604 to add further spike tolerance.

Example embodiments herein include power control circuitry that tolerates current overage spikes for current values and spike durations dictated by particular circuit breaker trip curves. This is suitably done in an environment where several switches may be activated concurrently or sequentially. When a current level exceeds a time for an estimated overcurrent, a switch having a highest current increase is suitably disconnected.

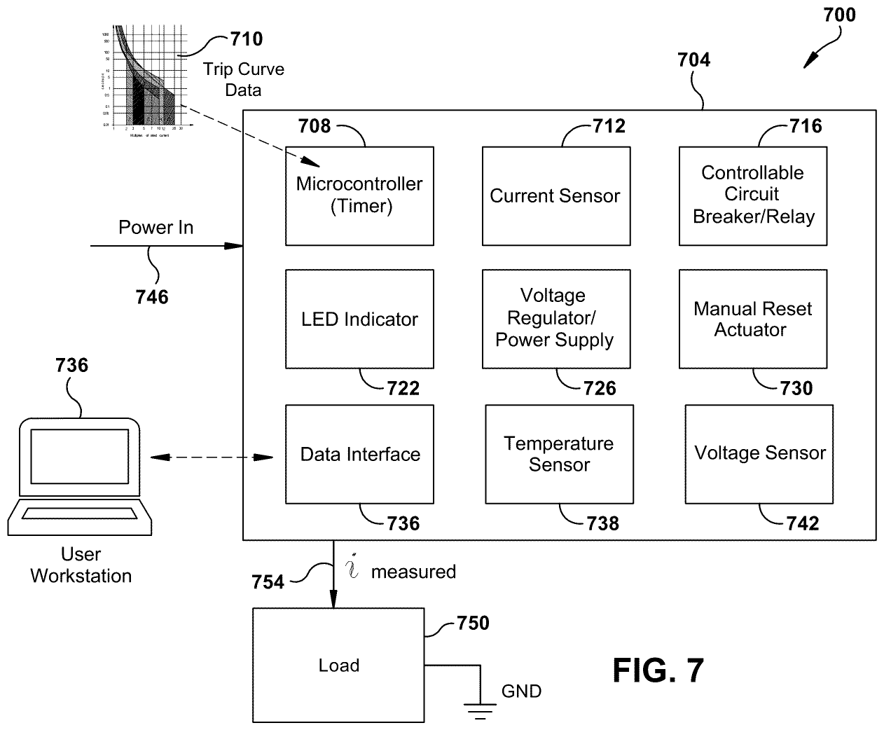

FIG. 7 illustrates a system 700 for overcurrent protection using dynamic trip curve evaluation. dynamic trip curve breaker 704 includes microcontroller 708, including one or more processors and memory, as detailed above. Microcontroller 708 suitably functions as a timer for operation as detailed below. Microcontroller memory stores data corresponding to one or more device trip curves 710. Also included in dynamic trip curve breaker 704 is current sensor 712, controllable circuit breaker or relay 716 and LED indicator 722. Voltage regulator/power supply 726 supplies circuit power for device operation that is suitably derived from input power or independent power, such as via battery or separate line connection. Dynamic trip curve breaker 704 also includes manual reset actuator 730 that facilitates a manual reset of a tripped breaker. Data interface 734 suitably provides for interaction with external data devices such as workstation 736. Workstation 736 suitably receives information related to operation of dynamic trip curve breaker 704, and provides programming and trip curve data. Also included is temperature sensor 738 and voltage sensor 742. Operation of dynamic trip curve breaker 704 includes receiving input power 746. Power to load 750 is measured, such as by monitoring load current 754.

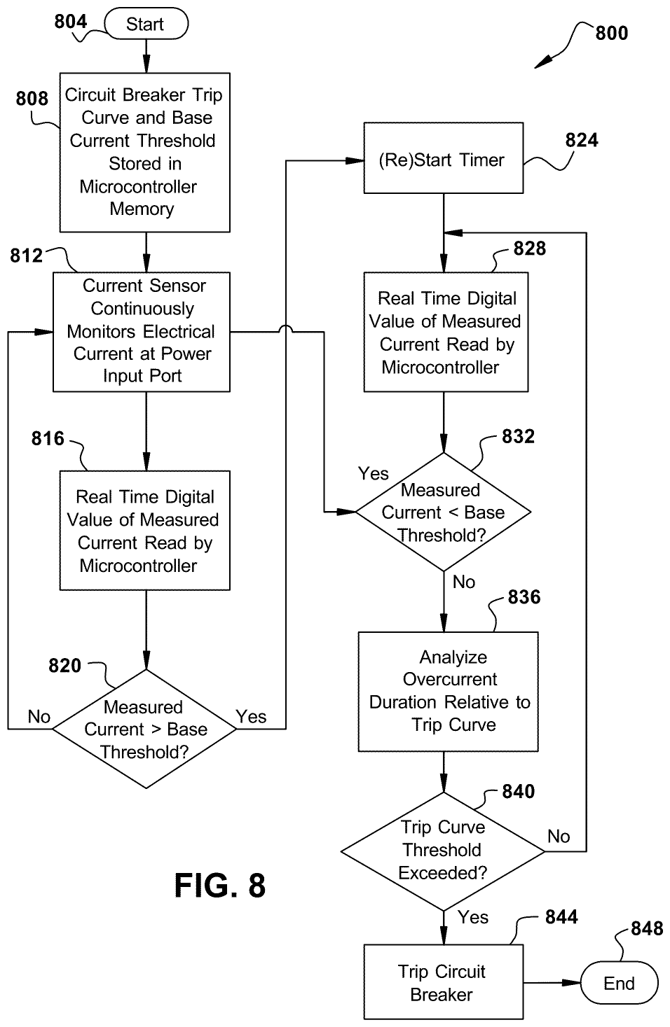

FIG. 8 illustrates an example embodiment of a flowchart 800 for a system and method for overcurrent protection using dynamic trip curve evaluation. The process commences at block 804 and proceeds to block 808 where circuit breaker trip curve data is stored in microcontroller memory. A current sensor continuously monitors electrical power at block 812 and a real time digital value is read and measured at block 816. A test is made at block 820 to determine if measured current exceeds a pre-established threshold level, such as a level corresponding to stored trip curve data. If not, the process returns to block 812.

If measured current exceeds the base threshold level at block 820, the process moves to block 824 wherein a timer is started, or restarted if previously used. A real time value of measured current is obtained by the microcontroller at block 828, and a check is made at block 832 to determine if the measured current has again dipped below the threshold level. If so, the process returns to block 812. If not, an overcurrent value and time duration from the timer is determined relative to the stored trip curve data at block 836. If the time and current remain in the trip curve's non-tripping zone, the process returns to block 828 for continued monitoring. A determination is made at block 840 as to whether the trip curve threshold is exceeded, the circuit breaker is tripped at block 844 and the process ends at block 848. A circuit breaker reset is suitably undertaken manually. The system may automatically or manually return to block 812 for continued monitoring after a breaker reset, which may be accompanied by a time delay.

An example of Arduino microcode to accomplish the above-described functionality follows:

```
// Pin Definitions
const int currentSensorPin = A0; // Analog pin for current sensor input
const int relayControlPin = 8; // Digital pin for relay control
const int ledStatusPin = 13; // Built-in LED for status indication
// Trip Curve Parameters
const float tripThreshold = 10.0; // Threshold in amps
const unsigned long maxDuration = 5000; // Maximum duration in
milliseconds (5 seconds)
// Variables
float currentReading = 0.0;
unsigned long overcurrentStartTime = 0;
bool overcurrentFlag = false;
void setup( ) {
  // Initialize pins
  pinMode(currentSensorPin, INPUT);
  pinMode(relayControlPin, OUTPUT);
  pinMode(ledStatusPin, OUTPUT);
  // Start serial communication for debugging
  Serial.begin(9600);
  // Ensure relay is initially closed (allow current flow)
  digitalWrite(relayControlPin, HIGH);
}
void loop( ) {
  // Read the current from the sensor
  currentReading = readCurrent( );
  // Check if the current exceeds the trip threshold
  if (currentReading > tripThreshold) {
    if (!overcurrentFlag) {
      // Start tracking time if it's the first detection of overcurrent
      overcurrentFlag = true;
      overcurrentStartTime = millis( );
    } else {
      // Check if the overcurrent duration exceeds the allowed time
      if (millis( ) − overcurrentStartTime > maxDuration) {
        tripCircuit( ); // Disconnect the load
      }
    }
  } else {
    // Reset the flag and timer if the current returns to safe levels
    overcurrentFlag = false;
    overcurrentStartTime = 0;
  }
  // Status indicator
  updateStatus( );
  // Small delay for stability
  delay(100);
}
// Function to read current from the sensor
float readCurrent( ) {
  int sensor Value = analogRead(currentSensorPin);
  float voltage = sensorValue * (5.0 / 1023.0); // Convert to voltage
  float current = voltage * 10.0; // Example calibration: 10 A per volt
  Serial.println(″Current (A): ″ + String(current));
  return current;
}
// Function to trip the circuit by opening the relay
void tripCircuit( ) {
  digitalWrite(relayControlPin, LOW); // Open the relay
  Serial.println(″Circuit tripped! Load disconnected.″);
}
// Function to update the status LED
void updateStatus( ) {
  if (overcurrentFlag) {
    digitalWrite(ledStatusPin, HIGH); // LED ON for overcurrent
    condition
  } else {
    digitalWrite(ledStatusPin, LOW); // LED OFF for normal operation
  }
}
```

The foregoing example code functions as follows:

### Initialization:

a. The currentSensorPin reads current values, and the relayControlPin controls the load connection.
b. The system initializes the relay to allow current flow at startup.

### Current Measurement:

c. The readCurrent( ) function converts analog sensor readings into amperes based on calibration factors.

### Overcurrent Detection:

d. If the current exceeds the threshold (tripThreshold), the system starts a timer.
e. If the duration of the overcurrent exceeds the maximum allowable time (maxDuration), the relay disconnects the load by calling tripCircuit( ).

### Reset Conditions:

f. If the current drops below the threshold, the timer and overcurrent flag are reset.

### Status Indication:

g. The built-in LED provides a visual indication of the system's state, turning on during overcurrent conditions.

### Serial Output:

h. Current readings and system status are printed to the serial monitor for debugging and monitoring purposes.

It will thus be seen that the objects set forth above, among those made apparent from the preceding description, are efficiently attained, and since certain changes may be made in the constructions set forth without departing from the spirit and scope of the disclosure, it is intended that all matter contained in the above description and shown in the accompanying drawings shall be interpreted as illustrative and not in a limiting sense. The disclosure has been described with reference to preferred and alternate embodiments. Modifications and alterations will become apparent to those skilled in the art upon reading and understanding the detailed discussion of the disclosure provided herein. This disclosure is intended to include all such modifications and alterations insofar as they come within the scope of the present disclosure. It is also to be understood that the following claims are intended to cover all of the generic and specific features of the disclosure herein described and all statements of the scope of the disclosure, which, as a matter of language, might be said to fall therebetween.

To aid the Patent Office and any readers of this application and any resulting patent in interpreting the claims appended hereto, applicants do not intend any of the appended claims or claim elements to invoke 35 U.S.C. 112(f) unless the words “means for” or “step for” are explicitly used in the particular claim.

What is claimed:

1. An intelligent circuit breaker system comprising:
a current sensor that is configured to measure electrical current applied to a power line load;
a memory storing trip curve data corresponding to a trip curve of an associated circuit breaker;
a processor that is configured to receive a measured current value from said current sensor; said processor further configured to compare said measured current valve by said current sensor with a pre-established threshold value; and wherein when said measured current value exceeds a pre-established threshold value, said processor further is configured to
i. start a timer,
ii. determine whether a time duration from said start of said timer, and
iii. disconnect said load when said measured current value exceeds a level and duration specified by said trip curve data.

2. The system as defined in claim 1, wherein said processor is further configured to adjust said pre-established threshold value based on one or more environmental factors; said environmental factors include one or more factors selected from the group consisting of ambient temperature, ambient pressure, and ambient humidity.

3. The system as defined in claim 1, further comprising a relay operatively coupled to said processor, and wherein said processor is configured to send a control signal to said relay to disconnect said load when said measured current value exceeds said level and duration specified by said trip curve data.

4. The system as defined in claim 1, wherein said processor is further configured to log in a data storage for diagnostic or monitoring purposes one or more of said measured current value, timer duration, and/or disconnection events.

5. The system as defined in claim 1, wherein said trip curve data stored in said memory includes multiple predefined trip curves; said processor is configured to select an appropriate trip curve based on said type of load connected to said power line.

6. The system as defined in claim 1, further comprising a user interface configured to display one or more of real-time current values, said status of said timer, and/or whether said load has been disconnected.

7. The system as defined in claim 1, wherein said processor is further configured to reset said timer and reconnect said load automatically when said measured current value falls below said pre-established threshold value for a predefined recovery period.

8. A method for managing overcurrent conditions in an intelligent circuit breaker system comprising:
measuring electrical current applied to a power line load using a current sensor;
storing trip curve data corresponding to a trip curve of an associated circuit breaker in a memory;
receiving a measured current value from said current sensor;
comparing said measured current value with a pre-established threshold value; and
disconnecting said load when said measured current value exceeds a level and duration specified by said trip curve data.

9. The method as defined in claim 8, further comprising starting a timer when said measured current value exceeds said pre-established threshold value and monitoring said duration of said overcurrent condition.

10. The method as defined in claim 8, wherein said trip curve data includes multiple predefined trip curves; said method further comprises selecting a specific trip curve based on said type of load connected to said power line.

11. The method as defined in claim 8, further comprising logging in a storage module for diagnostic purposes one or more of said measured current value, duration of said overcurrent condition, and/or load disconnection events.

12. The method as defined in claim 8, further comprising adjusting said pre-established threshold value dynamically based on one or more environmental factors; said environmental factors include one or more factors selected from the group consisting of ambient temperature, ambient pressure, and ambient humidity.

13. The method as defined in claim 8, further comprising reconnecting said load automatically when said measured current value falls below said pre-established threshold value for a predefined recovery period.

14. The method as defined in claim 8, further comprising displaying one or more real-time current values, timer status, and/or disconnection status on a user interface.

15. A non-transitory computer-readable medium containing instructions that, when executed by a processor, causes said processor to:
receive a current value measured by a current sensor;
compare said measured current value with a pre-established threshold value;
start a timer when said measured current value exceeds said pre-established threshold value; and
disconnect said load when said measured current value exceeds a level and duration specified by trip curve data stored in a memory.

16. The medium as defined in claim 15, wherein said instructions further cause said processor to log into a storage module for later analysis one or more of said measured current values, timer durations, and/or disconnection events.

17. The medium as defined in claim 15, wherein said instructions further cause said processor to dynamically select a trip curve from multiple predefined trip curves stored in the memory that is based on the type of load connected to said power line.

18. The medium as defined in claim 15, wherein said instructions further cause said processor to update said pre-established threshold value based on information from environmental sensor data; said environmental senor data including data of one or more ambient temperature, ambient pressure, and ambient humidity.

19. The medium as defined in claim 15, wherein said instructions further cause said processor to display one or more of real-time current values, overcurrent durations, and/or disconnection statuses on a user interface.

20. The medium as defined in claim 15, wherein said instructions further cause said processor to automatically reset said timer and reconnect said load when said current value falls below said pre-established threshold for a predefined recovery period.
